(19) United States
(12) Patent Application Publication
(10) Pub. No.: US 2019/0136708 A1
(43) Pub. Date: May 9, 2019

(54) ACTIVE CLEARANCE CONTROL COOLING AIR RAIL WITH FINGERS

(71) Applicant: General Electric Company, Schenectady, NY (US)

(72) Inventors: Merin Sebastian, Bangalore (IN); Scott Alan Schimmels, Miamisburg, OH (US); Daniel Anthony Dyer, Dayton, OH (US); Gordon Tajiri, Waynesville, OH (US); Vinod Shashikant Chaudhari, Bengaluru, IN (US); Yanzhe Yang, Mason, OH (US); Dattu Guru Venkata Jonnalagadda, Bangalore (IN)

(21) Appl. No.: 15/807,988

(22) Filed: Nov. 9, 2017

(51) Int. Cl. F01D 11/24; F01D 25/24

(52) U.S. Cl. CPC F01D 11/24; F05D 2260/201; F05D 2220/323; F01D 25/243

(57) ABSTRACT

Arcuate panel includes at least one axially extending panel header with arcuate outer and inner portions. Inner portion includes open portions of axially spaced apart arcuate cooling air spray rails attached to header and in fluid communication with plenum within header. Plurality of axially extending hollow fingers extend axially away from one of the spray rails and impingement spray holes in the spray rails and the fingers. Arcuate overhang may extend axially aftwardly from one of the spray rails and fingers may depend from overhang. An outer casing including axially spaced apart forward and aft casing flanges attached to or integral and monolithic with outer casing may be circumscribed by a hoop of the arcuate panels. The fingers may extend away from one of the spray rails and between nuts screwed on bolts disposed through one of the forward and aft casing flanges.

### BACKGROUND OF THE INVENTION

### Field of the Invention

This invention relates to aircraft gas turbine engine active clearance control system thermal air distribution systems and, more particularly, panels with air rails for spraying air on a casing of the engine.

### Discussion of the Background Art

Engine performance parameters such as thrust, specific fuel consumption (SFC), and exhaust gas temperature (EGT) margin are strongly dependent upon clearances between turbine blade tips and static seals or shrouds surrounding the blade tips. Active clearance control (ACC) is a well known method to modulate a flow of cool or relatively hot air from the engine fan and/or compressor and spray it on high and low pressure turbine casings to shrink the casings relative to the high and low pressure turbine blade tips under steady state, high altitude cruise conditions. The air may be flowed to or sprayed on other static structures used to support the shrouds or seals around the blade tips. Such static structures include flanges or pseudo-flanges.

One type of active clearance control system includes a thermal air distribution manifold encircling a portion of the outer casing. The manifold includes a circular array of panels and an annular supply tube is connected in fluid supply relationship to plenums of headers of the panels. Cooling air channels or rails of the panel are attached to and in fluid connection with the header. The panels encircle the casing and channels form continuous spray tubes or rails for spraying cooling air on casing. Examples of manifolds are disclosed in U.S. Pat. No. 7,597,537 to Bucaro, et al., issued Oct. 6, 2009, entitled “Thermal control of gas turbine engine rings for active clearance control” and United States Patent Application No. 2014/0030066 to Schimmels et al., published Jan. 30, 2014, entitled “ACTIVE CLEARANCE CONTROL MANIFOLD SYSTEM”, and United States Patent Application No. 2016/0003086 to Christophe Jude Day et al., published Jan. 7, 2016, entitled “GAS TURBINE ENGINE SPRING MOUNTED MANIFOLD”. U.S. Pat. No. 7,597,537 and United States Patent Application Nos. 2014/0030066 and 2016/0003086 are assigned to General Electric Company, the same assignee as the assignee of this patent and are hereby incorporated herein by reference.

The panels typically include cooling air channels, spray tubes, or rails encircling the casing for spraying cooling air on the casing. The last one or two rails are prevented from being located closer to the high pressure turbine (HPT) case by axially protruding bolts used to bolt together axially adjoining HPT casings or cases. This also increases MACH number within these ACC panels. This reduces the cooling effectiveness of impinged air from the panels and increases the amount of cooling air needed and reduces engine efficiency or specific fuel consumption (SFC).

It is desirable to provide a more efficient ACC panel and air cooling rail to better impingement cool the HPT casing.

### SUMMARY

An arcuate panel includes at least one axially extending panel header including arcuate outer and inner portion. The inner portion includes open portions of axially spaced apart arcuate cooling air spray rails attached to the header. The spray rails are in fluid communication with a plenum within the header, and a plurality of axially extending hollow fingers extend axially away from at least one of the fourth spray rails.

The arcuate panel may further include spray holes in the spray rails and in the fingers. The spray holes may be impingement spray holes.

One of the fourth spray rail may include the fingers depending radially inwardly from an arcuate overhang extending axially aftwardly from one of the fourth spray rails.

An annular tube segment may be connected to and open to the plenum. The header, the spray rails, the fingers, and the annular tube segment may all be integral, monolithic, and electroformed together. The header, the spray rails, the fingers, and the annular tube segment may be electroformed together by electrodeposition.

The arcuate panel may include arcuate inner walls spaced radially inwardly of an arcuate outer wall of the outer portion of the header, the arcuate inner walls extending axially in between the open portions, a plenum within the header extending radially between the arcuate inner walls and the arcuate outer wall, and the plenum extending circumferentially between circumferentially spaced apart first and second side walls of the header.

A thermal control assembly includes a thermal air distribution manifold encircling a portion of an outer casing, the outer casing including axially spaced apart forward and aft casing flanges, forward and aft thermal control rings attached to or integral and monolithic with the outer casing, the manifold including an annular row or hoop of the arcuate panels. Each of the arcuate panel includes at least one axially extending panel header including arcuate outer and inner portions, the inner portion includes open portions of axially spaced apart arcuate cooling air spray rails attached to the header, the spray rails in fluid communication with a plenum within the header, and a plurality of axially extending hollow fingers extend axially away from one of the spray rails and between nuts screwed on bolts disposed through bolt holes in one of the forward and aft casing flanges.

One or more of the spray rails may be axially spaced apart from and partially radially coextensive with one or more of the forward and aft thermal control rings. The thermal control assembly may further include a segmented annular tube including the tube segment of the panels.

At least some of the spray holes in the fingers may be located and oriented to impinge air on the aft casing flange between the nuts screwed on the bolts disposed through the bolt holes in one of the forward and aft casing flanges.

### BRIEF DESCRIPTION OF THE DRAWINGS

The subject matter for which patent claim coverage is sought is particularly pointed out and claimed herein. The subject matter and embodiments thereof, however, may be best understood by reference to the following description taken in conjunction with the accompanying drawing figures in which:

FIG. 1 is a schematic cross-section view illustration of an aircraft gas turbine engine including an exemplary active clearance control system with a cooling air rail with aft extending fingers.

FIG. 2 is a perspective view illustration of an air distribution manifold with panels having cooling air rails with aft extending fingers circumscribed about an engine casing of the aircraft gas turbine engine illustrated in FIG. 1.

FIG. 3 is a sectional view illustration taken circumferentially through the manifold, panel, and rail with the finger illustrated in FIG. 2.

FIG. 4 is a sectional view illustration taken circumferentially through the manifold, panel, and rail without the finger illustrated in FIG. 2.

FIG. 5 is a partially cut-away perspective view illustration of a portion of the rail with the fingers between bolts through an aft flange of the engine casing illustrated in FIG. 2.

FIG. 6 is a radially inwardly looking perspective view illustration of a portion of the panel with the rail with the fingers of the air distribution manifold illustrated in FIG. 2.

FIG. 7 is a radially outwardly looking perspective view illustration of a portion of the panel with the rail with the fingers of the air distribution manifold illustrated in FIG. 2.

FIG. 8 is a partially cut-away perspective view illustration of portions of circumferentially adjoining panels having rails with the fingers between bolts through an aft flange of the engine casing illustrated in FIG. 2.

FIG. 9 is a schematical sectional view illustration taken axially circumferentially of the manifold and panel and rail with the fingers illustrated in FIG. 8.

FIG. 10 is a schematical sectional view illustration taken circumferentially through the manifold and panel and rails with the fingers illustrated in FIG. 6.

### DETAILED DESCRIPTION

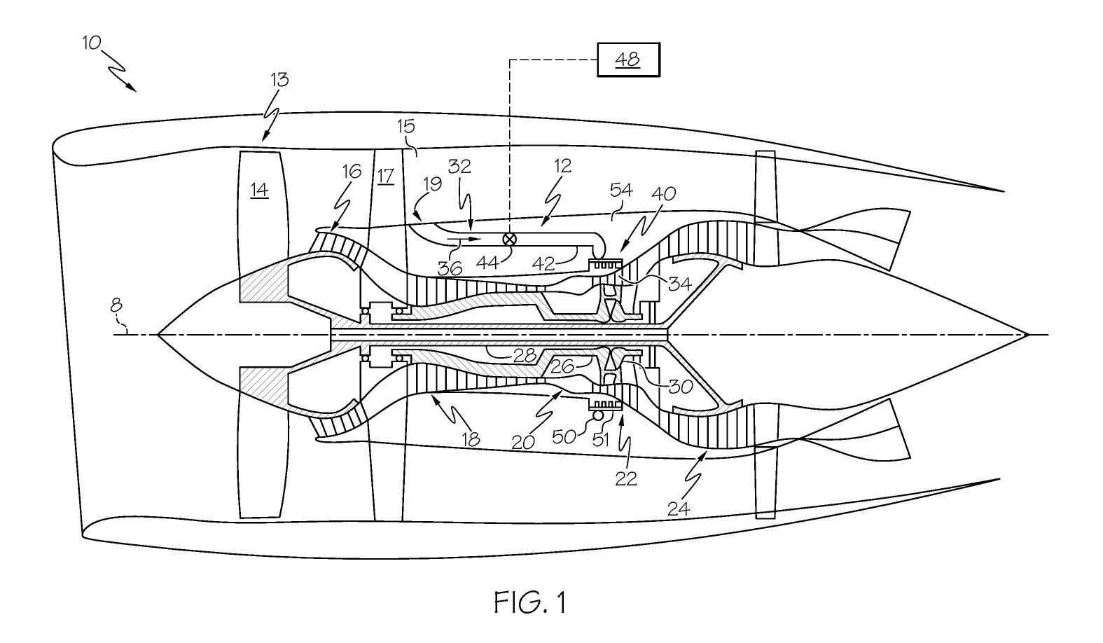

Schematically illustrated in cross-section in FIG. 1 is an exemplary embodiment of an aircraft gas turbine engine 10 including a thermal control apparatus illustrated herein as an active clearance control system 12. The engine 10 has, in downstream serial flow relationship, a fan section 13 including a fan 14, a booster or low pressure compressor (LPC) 16, a high pressure compressor (HPC) 18, a combustion section 20, a high pressure turbine (HPT) 22, and a low pressure turbine (LPT) 24. A high pressure shaft 26 disposed about an engine axis 8 drivingly connects the HPT 22 to the HPC 18 and a low pressure shaft 28 drivingly connects the LPT 24 to the LPC 16 and the fan 14. The HPT 22 includes an HPT rotor 30 having turbine blades 34 mounted at a periphery of the rotor 30.

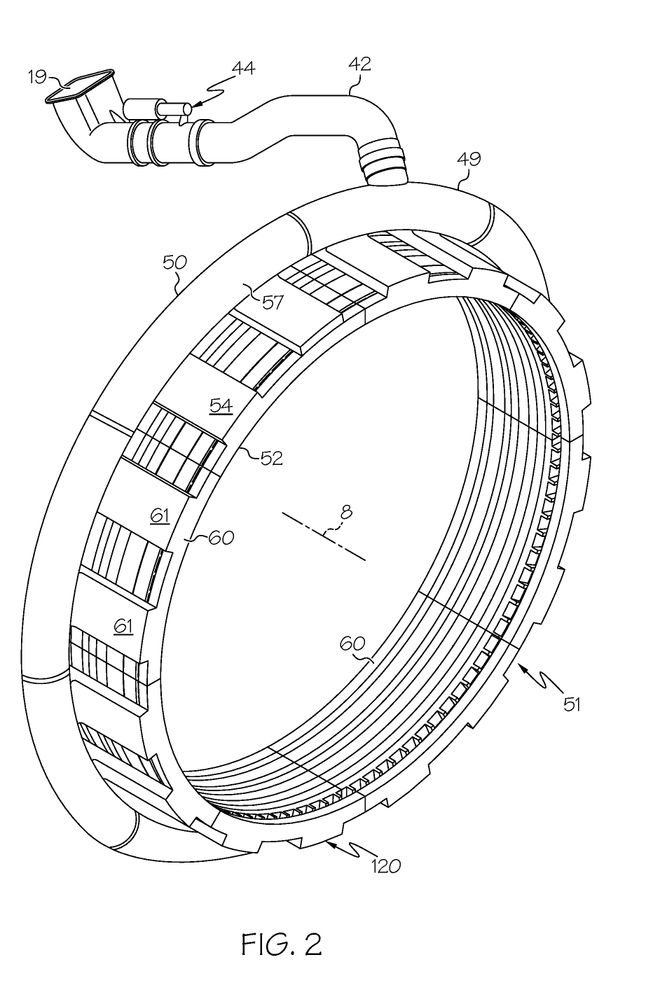

Referring to FIGS. 1 and 2, a compressed fan air supply 32 is used as a source for thermal control air 36 supplied to a turbine blade tip clearance control apparatus or thermal control assembly generally shown at 40 through an axially extending air supply tube 42. An air valve 44 disposed in the air supply tube 42 controls the amount of thermal control air flowed therethrough. The thermal control air 36 serves as cooling air in the exemplary embodiment of the active clearance control system 12 illustrated herein. The cooling air is controllably flowed from a fan bypass duct 15 surrounding the booster or low pressure compressor (LPC) 16 through the axial air supply tube 42 to an air distribution manifold 51 of the turbine blade tip clearance control apparatus 40.

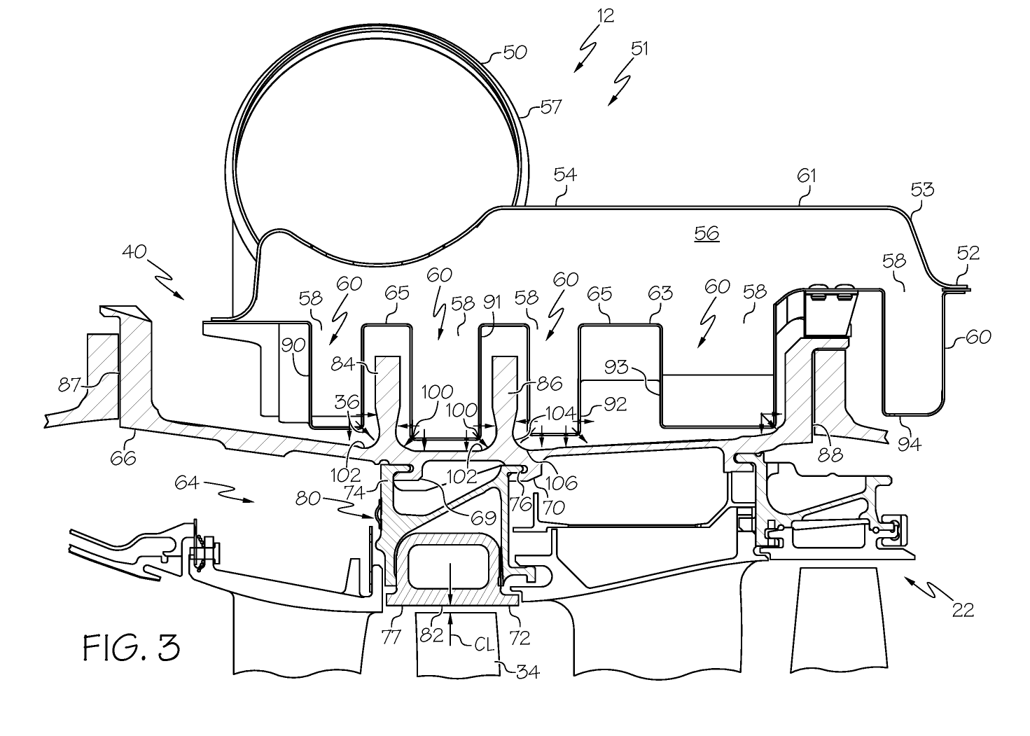

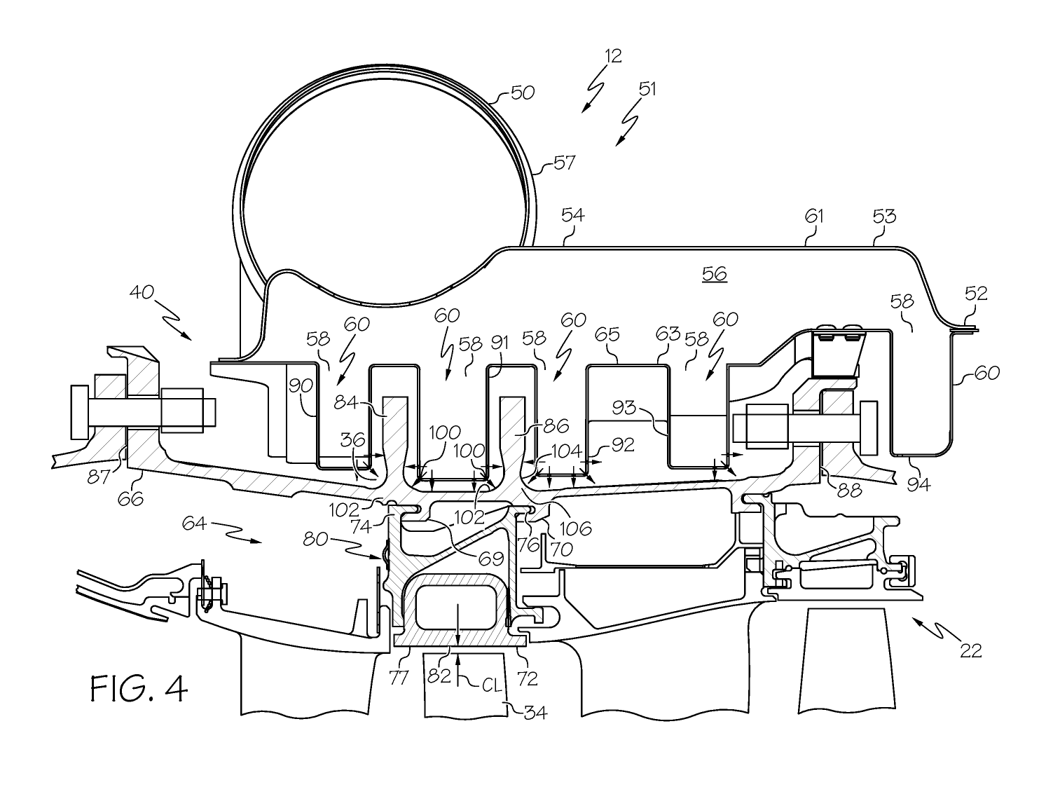

Further referring to FIG. 2, the air distribution manifold 51 includes an annular header 50 illustrated herein as a segmented annular tube 49 circumscribed about the engine axis 8. The air valve 44 and the amount of thermal control air 36 impinged for controlling turbine blade tip clearances CL, illustrated in FIGS. 3 and 4, is controlled by a controller 48, illustrated in FIG. 1. The controller 48 may be a digital electronic engine control system such as a Full Authority Digital Electronic Control (FADEC). The FADEC may also control temperature of the thermal control air 36, if so desired. An air supply inlet 19 to the axial air supply tube 42 is located downstream of exit guide vanes 17 disposed in the fan bypass duct 15 downstream of the fan 14. The annular header 50 is circumferentially positioned around a radially outer casing 66 of the high pressure turbine 22 as illustrated in FIG. 1.

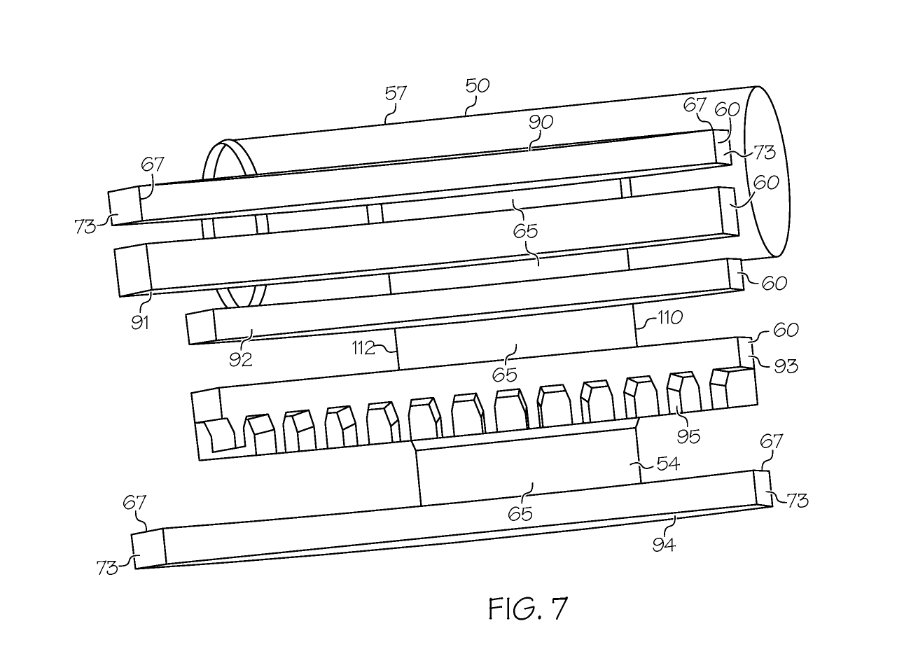

Referring to FIGS. 3-4, the turbine blade tip clearance control apparatus generally shown at 40 includes an annular row or hoop 120 of arcuate panels 52 of the air distribution manifold 51 circumscribed about the engine axis 8. The arcuate panels 52 are circumferentially positioned around a radially outer casing 66 of the high pressure turbine 22. Each arcuate panel 52 includes one or more axially extending supply panel headers 54. Each header 54 includes an arcuate outer portion 53 and an arcuate inner portion 63. The inner portion 63 includes open portions 58 of axially spaced apart arcuate cooling air spray rails 60 attached to the headers 54 which may be referred to as spray tubes or channels as illustrated in FIGS. 2-4, 6-7, and 10. The open portions 58 may be referred to as slots in the spray rails 60.

Referring to FIGS. 3-4 and 6, the arcuate inner portion 63 includes arcuate inner walls 65 spaced radially inwardly of an arcuate outer wall 61 of the outer portion 53 of the header 54 and extend axially in between the open portions 58. The inner walls 65 extend circumferentially between circumferentially spaced apart first and second side walls 110, 112 of the header 54. A plenum 56 within the header 54 generally extends radially between the arcuate inner walls 65 and the arcuate outer wall 61 and circumferentially between circumferentially spaced apart first and second side walls 110, 112 of the header 54. The supply panel headers 54 may be boxes as illustrated in the exemplary embodiment of the panels 52 illustrated and disclosed herein.

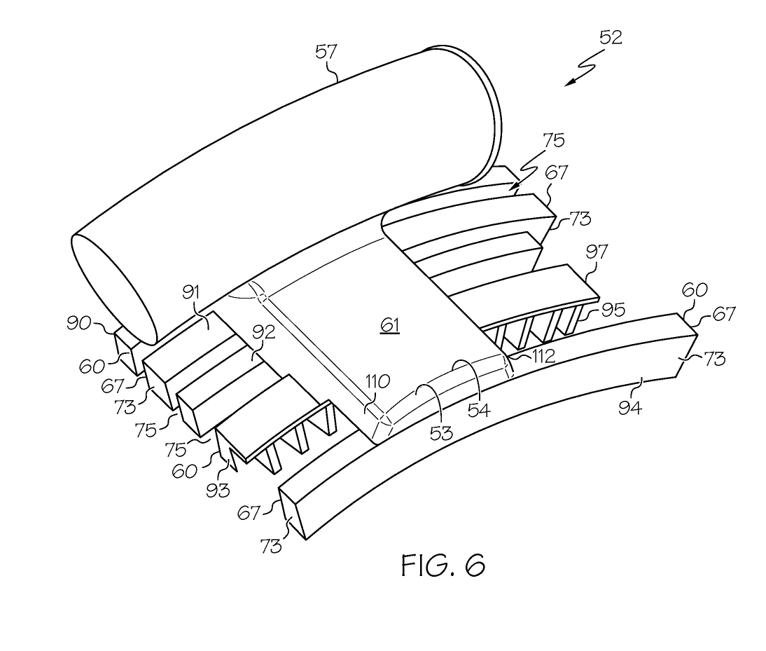

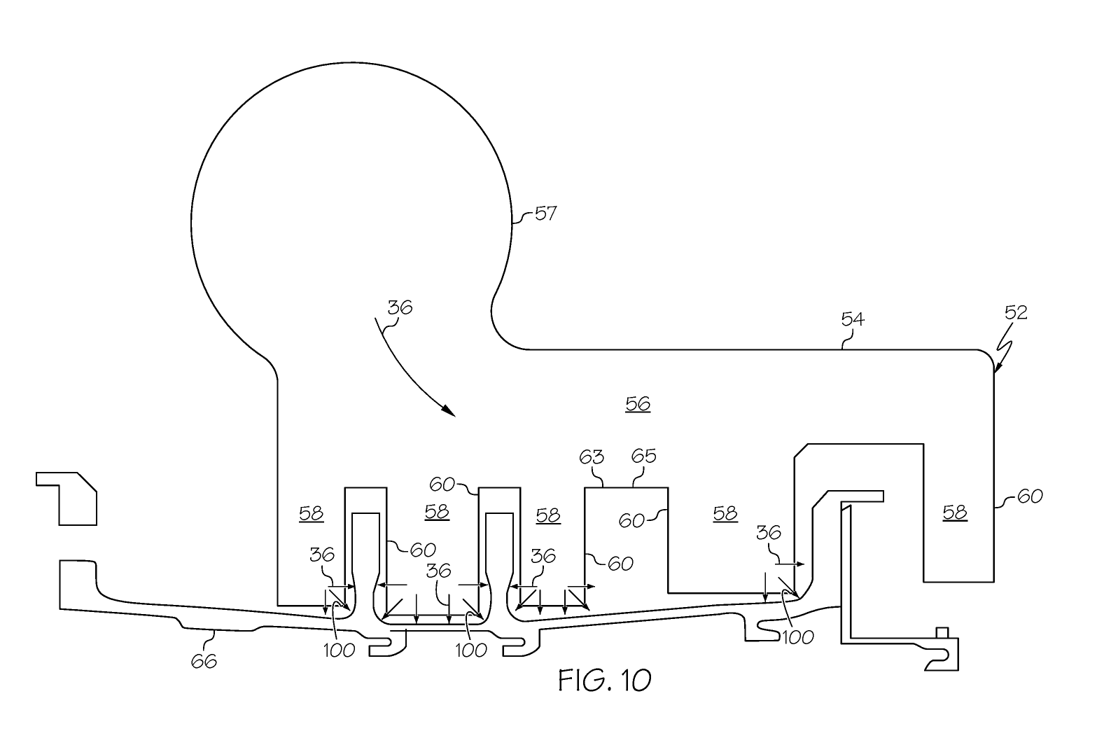

Referring to FIGS. 3-4, 6-7, and 10, each of the panel headers 54 includes an annular tube segment 57 of the segmented annular tube 49. The annular tube segment 57 is connected to the header 54 and open to the plenum 56 and provides the thermal control air 36 to the spray rails 60 as illustrated in FIG. 10. The open portions 58 allow the cooling or control air 36 to flow from the plenums 56 into a plurality of cooling air spray rails 60 which may be referred to as spray tubes or channels as illustrated in FIGS. 3-5 and 10. The exemplary embodiment of the arcuate panel 52 illustrated herein includes 5 spray rails 60 depending radially inwardly from the header 54 of the arcuate panels 52. The spray rails 60 are arcuate segments closed and sealed at their circumferential ends 67 with caps 73 as illustrated in FIG. 6. Circumferentially extending exhaust spaces 75 between the spray rails 60 allow the spent cooling or control air 36 to exhaust or flow out from the radially outer casing 66 of the high pressure turbine 22 after the control air has cooled the casing.

As schematically illustrated in FIG. 2, the exemplary embodiment of the air distribution manifold 51 includes 8 arcuate panels 52 but more or less may be used. A large aircraft gas turbine engine like a GE90 may use 8 arcuate panels 52 with 2 panel headers 54 per panel 52. A smaller aircraft gas turbine engine like a LEAP CFM56/CF34 may use 4 arcuate panels 52 with 2 panel headers 54 per panel.

Illustrated in FIGS. 3 and 4 is a portion of a first turbine stator assembly 64 attached to a radially outer casing 66 of the HPT 22. The stator assembly 64 includes an annular segmented stator shroud 72 having shroud segments 77 mounted to an annular segmented shroud support 80 of the first turbine stator assembly 64. The shroud support 80 is mounted by forward and aft shroud hooks 74, 76 to forward and aft case hooks 69, 70 of the outer casing 66. The shroud 72 circumscribes turbine blades 34 of the rotor 30 (illustrated in FIG. 1) and helps reduce the flow from leaking around a radial outer blade tip 82 of the blade 34. The active clearance control system 12 is used to minimize a radial blade tip clearance CL between the outer blade tip 82 and the shroud 72, particularly during cruise operation of the engine 10.

It is well known in the industry that small turbine blade tip clearances CL provide lower operational specific fuel consumption (SFC) and, thus, large fuel savings. Forward and aft thermal control rings 84, 86 (as illustrated in FIGS. 3-4) are provided to more effectively control blade tip clearance CL with a minimal amount of time lag and thermal control (cooling or heating depending on operating conditions) air flow. The forward and aft thermal control rings 84, 86 are attached to or otherwise associated with the outer casing 66 and may be integral and monolithic with the outer casing 66. The forward and aft thermal control rings 84, 86 illustrated herein may also be referred to as pseudo-flanges.

The radially outer casing 66 of the high pressure turbine 22 incudes axially spaced apart forward and aft casing flanges 87, 88 to bolted the high pressure turbine (HPT) 22 to the combustion section 20 and the low pressure turbine (LPT) 24. Bolts 96 and nuts 101 are used to fasten the forward and aft casing flanges 87, 88 of the casing 66 to the combustion section 20 and the low pressure turbine (LPT) 24 respectively. The forward and aft casing flanges 87, 88 may also be used as thermal control rings or otherwise be sprayed with thermal control air 36. The thermal control rings provide thermal control mass to more effectively move the shroud segments 77 radially inwardly (and outwardly if so designed) to adjust the blade tip clearances CL. The forward and aft case hooks 69, 70 are located generally radially inwardly of an axially near or at the forward and aft thermal control rings 84, 86 to improve response to changes in thermal air impinging the control rings. The number of thermal control rings may be more than 2 depending on the size and operating temperatures of the casing 66.

The plurality of spray rails 60 are illustrated herein as including first, second, third, fourth and fifth spray rails 90-94 having spray holes 100. The spray holes 100 may be impingement spray holes oriented to impinge thermal control air 36 (cooling air) onto surfaces 102 on and near the forward and aft thermal control rings 84, 86 and the aft casing flange 88 to move the shroud segments 77 radially inwardly to tighten up or minimize the blade tip clearances CL. The surfaces 102 include at least portions of fillets 104 between the outer casing 66 and the forward and aft thermal control rings 84, 86. The spray rails 60 are slightly spaced apart from and partially radially coextensive with the thermal control rings to facilitate and enhance impingement cooling by thermal control air 36 (cooling air) injected through the spray holes 100.

Some of the spray holes 100 may be oriented to impinge thermal control air 36 (cooling air) into the centers 106 of the fillets 104 of the forward and aft thermal control rings 84, 86 to cause the shroud segments 77 to move radially inwardly to tighten up or minimize the blade tip clearances CL. The first spray rail 90 is axially located forward of the forward thermal control ring 84. The second spray rails 91 is axially located between the forward and aft thermal control rings 84, 86 and has two circular rows 99 of the spray holes 100 oriented to impinge thermal control air 36 into the centers 106 of the fillets 104. The third spray rails 92 is axially located aft of the aft thermal control ring 86.

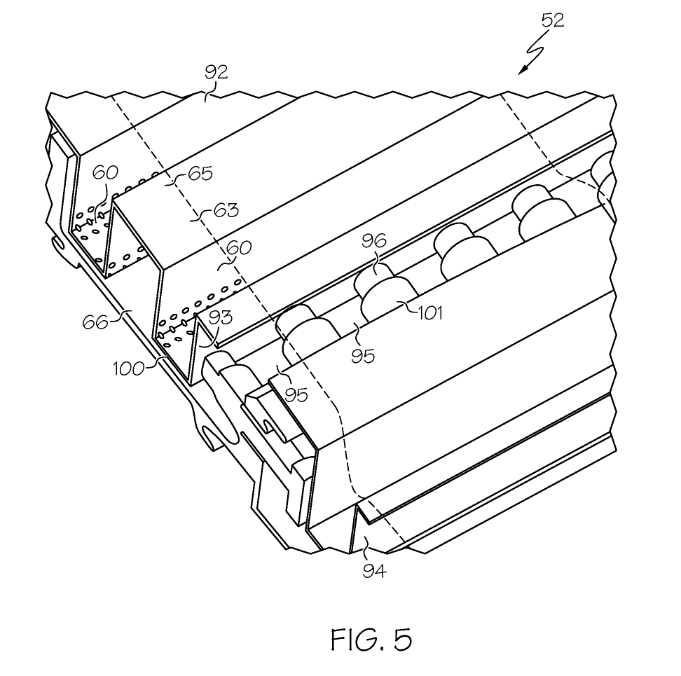

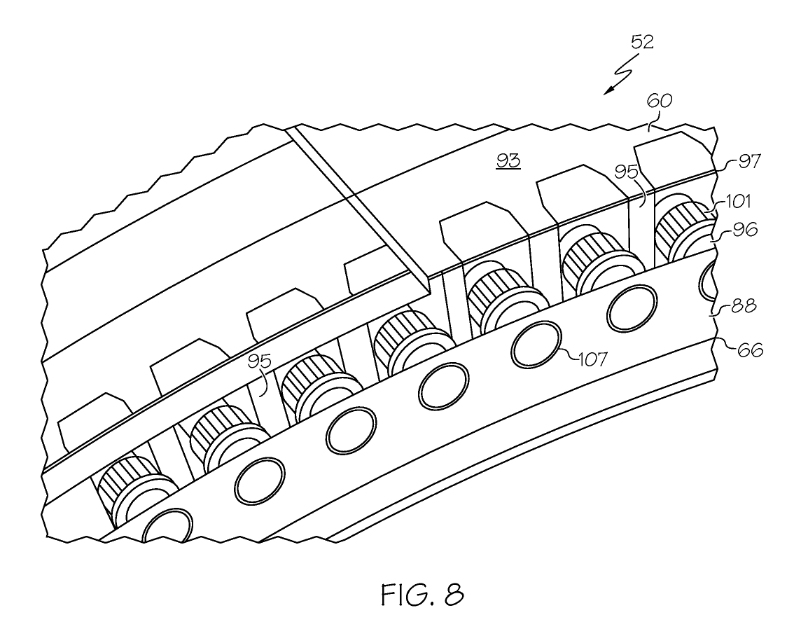

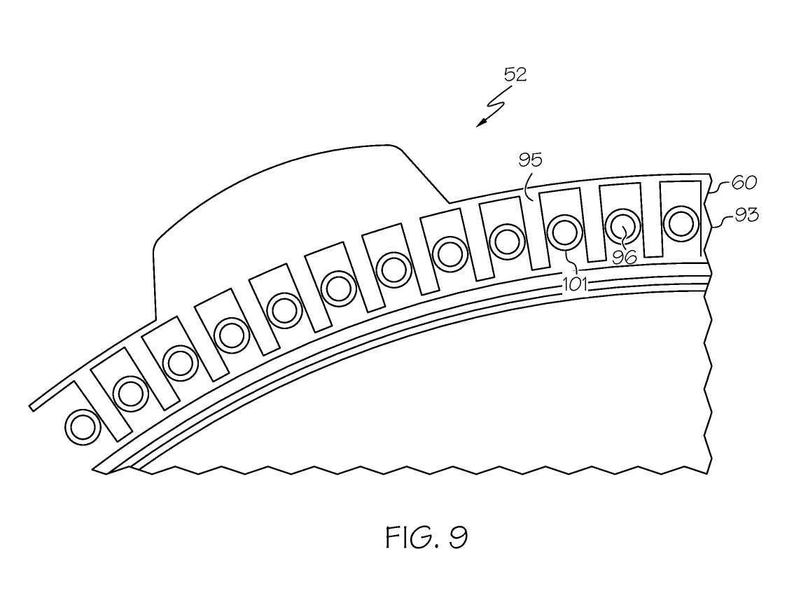

Referring to FIGS. 5-10, the fourth spray rails 93 includes axially aftwardly extending hollow fingers 95 extending between the nuts 101 screwed on the bolts 96 disposed through bolt holes 107 in the aft casing flange 88. The spray holes 100 are oriented to impinge the thermal control air 36 (cooling air) on a desired positions on the outer casing 66 of the HPT 22. The axially aftwardly extending hollow fingers 95 allows the spray holes 100 in the fingers 95 and the fourth spray rails 93 to be closer to the radially outer casing 66 and the aft casing flange 88 of the outer casing 66 of the high pressure turbine 22, thus, making the impingement cooling more affective. At least some of the spray holes 100 in the fingers 95 may be located and oriented to impinge on the aft casing flange 88 between the nuts 101 screwed on the bolts 96 disposed through bolt holes 107 in the aft casing flange 88. The fourth spray rail 93 includes an arcuate overhang 97 extending axially aftwardly from the fourth spray rail 93 and the fingers 95 depend radially inwardly from the arcuate overhang 97. The arcuate overhang 97 provides support and stiffness for the fingers 95.

Electroforming methods may be used to manufacture the arcuate panels 52 with a spray rail 60, such as the fourth spray rails 93, including the axially aftwardly extending hollow fingers 95. Electroforming may be electrodeposition upon a mandrel or mold that is subsequently separated from the deposit. It is, therefore, a method of fabricating parts that are usually free standing once separated from the mandrel. The electroformed arcuate panels 52 are integral and monolithic one piece parts. The electroformed arcuate panels 52 include the panel headers 54, the annular tube segment 57, the spray rails 60, and fingers 95.

There are multiple methods for making a mold or mandrel for electroforming. One method uses aluminum for the mold or mandrel. Electrodeposition is performed on the mold or mandrel and then aluminum is etched out in a caustic solution. This leaves behind the deposited component such as the panel and its features.

Another method uses non-conducting substances like wax or plastic etc. to the make mold or mandrel. A conductive coating, typically, graphite paint, platinum undercoat, silver paste, is applied on to the surface of the mandrel or mold. Electrodeposition is performed on top of the conductive coating and the wax or plastic is melted out.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

1. An arcuate panel comprising:
at least one axially extending panel header including arcuate outer and inner portions,
the inner portion including open portions of axially spaced apart arcuate cooling air spray rails attached to the header,
the spray rails in fluid communication with a plenum within the header, and
a plurality of axially extending hollow fingers extending axially away from at least one of the spray rails.

2. The arcuate panel as claimed in claim 1, further comprising spray holes in the spray rails and the fingers.

3. The arcuate panel as claimed in claim 2, further comprising the spray holes being impingement spray holes.

4. The arcuate panel as claimed in claim 1, further comprising one of the spray rails including an arcuate overhang extending axially aftwardly from one of the spray rails and the fingers depending radially inwardly from the arcuate overhang.

5. The arcuate panel as claimed in claim 1, further comprising an annular tube segment connected to the header and open to the plenum.

6. The arcuate panel as claimed in claim 5, further comprising the header, the spray rails, the fingers, and the annular tube segment being integral, monolithic, and electroformed together.

7. The arcuate panel as claimed in claim 6, further comprising the header, the spray rails, the fingers, and the annular tube segment being electroformed together by electrodeposition.

8. The arcuate panel as claimed in claim 7, further comprising one of the spray rails including an arcuate overhang extending axially aftwardly from one of the spray rails and the fingers depending radially inwardly from the arcuate overhang.

9. The arcuate panel as claimed in claim 8, further comprising impingement spray holes in the spray rails and the fingers.

10. The arcuate panel as claimed in claim 6, further comprising:
arcuate inner walls spaced radially inwardly of an arcuate outer wall of the outer portion of the header,
the arcuate inner walls extending axially in between the open portions,
the plenum within the header extending radially between the arcuate inner walls and the arcuate outer wall, and
the plenum extending circumferentially between circumferentially spaced apart first and second side walls of the header.

11. A thermal control assembly comprising:
a thermal air distribution manifold encircling a portion of an outer casing,
the outer casing including axially spaced apart forward and aft casing flanges,
forward and aft thermal control rings attached to or integral and monolithic with the outer casing,
the manifold including an annular row or hoop of arcuate panels,
each of the arcuate panel including at least one axially extending panel header including arcuate outer and inner portions,
the inner portion including open portions of axially spaced apart arcuate cooling air spray rails attached to the header,
the spray rails in fluid communication with a plenum within the header, and
a plurality of axially extending hollow fingers extending axially away from at least one of the spray rails and between nuts screwed on bolts disposed through bolt holes in one of the forward and aft casing flanges.

12. The assembly as claimed in claim 11, further comprising spray holes in the spray rails and the fingers.

13. The assembly as claimed in claim 12, further comprising the spray holes being impingement spray holes.

14. The assembly as claimed in claim 11, further comprising an annular tube segment connected to the header and open to the plenum.

15. The assembly as claimed in claim 14, further comprising the header, the spray rails, the fingers, and the annular tube segment being integral, monolithic, and electroformed together.

16. The assembly as claimed in claim 15, further comprising the header, the spray rails, the fingers, and the annular tube segment being electroformed together by electrodeposition.

17. The assembly as claimed in claim 16, further comprising impingement spray holes in the spray rails and the fingers.

18. The assembly as claimed in claim 17, further comprising one of the spray rails including an arcuate overhang extending axially aftwardly from one of the spray rails and the fingers depending radially inwardly from the arcuate overhang.

19. The assembly as claimed in claim 18, further comprising one or more of the spray rails axially spaced apart from and partially radially coextensive with one or more of the forward and aft thermal control rings.

20. The thermal control assembly as claimed in claim 19, further comprising a segmented annular tube including the tube segment of the panels.

21. The thermal control assembly as claimed in claim 19, further comprising at least some of the spray holes in the fingers located and oriented to impinge air on the aft casing flange between the nuts screwed on the bolts disposed through the bolt holes in one of the forward and aft casing flanges.
